(19) United States
(12) Patent Application Publication
(10) Pub. No.: US 2019/0102367 A1
(43) Pub. Date: Apr. 4, 2019

(54) TOGGLING BETWEEN TRACKED MARKUP FORMATTING AND BLACKLINE MARKUP FORMATTING

(71) Applicant: Philip Robert Smith, Arlington, VA (US)

(72) Inventor: Philip Robert Smith, Arlington, VA (US)

(21) Appl. No.: 16/150,389

(22) Filed: Oct. 3, 2018

Related U.S. Application Data
(60) Provisional application No. 62/567,365, filed on Oct. 3, 2017.

(51) Int. Cl. G06F 17/21; G06F 17/24; G06F 3/0481; G06F 3/0484

(52) U.S. Cl. CPC G06F 17/218; G06F 3/04842; G06F 3/04812; G06F 17/24

(57) ABSTRACT

Aspects of this disclosure relate generally to word processing applications, and more particularly to toggling between tracked markup formatting and blackline markup formatting. A method performed in accordance with aspects of the disclosure may comprise receiving, via one or more peripheral devices, one or more keystrokes, one or more mouseclicks, or one or more taps that select one or more characters in a word processing application, receiving, via the one or more peripheral devices, a keystroke, mouseclick, or tap that is associated with a command to convert blackline markup to tracked markup, identifying a toggling range that includes the selected one or more characters, and converting each blackline markup within the toggle range to tracked markup.

### CROSS-REFERENCE TO RELATED APPLICATION

The present Application for Patent claims the benefit of Provisional Patent Application No. 62/567,365, entitled “TOGGLING BETWEEN TRACKED MARKUP FORMATTING AND BLACKLINE MARKUP FORMATTING,” filed Oct. 3, 2017, pending, and assigned to the assignee hereof and hereby expressly incorporated herein by reference in its entirety.

### INTRODUCTION

Aspects of this disclosure relate generally to word processing applications, and more particularly to toggling between tracked markup formatting and blackline markup formatting.

A word processor is an electronic device or computer software application, controlled by a user, that performs the tasks of composing, editing, formatting, and printing of documents. Composing may comprise the placing of characters within a document. Editing may comprise deletion of characters, replacement of characters, or addition of characters. Formatting may comprise changes in font style, size, and/or color and addition or removal of italics, underlining, strikethrough, etc.

Before the advent of computer-based word processing, documents were typically produced with typewriters or some other mechanical device. When a typist wanted to draw the reader's attention to changes, convention dictated that the typist should type a first set of characters associated with the change (for example, a line of text), and then re-type a second set of characters directly over the first set of characters. The second set of characters may comprise a series of underscores beneath each character in the first set (indicating characters that are inserted) or a series of hyphens on top of each character in the first set (indicating characters that are deleted). In the finished document, a reader could easily identify characters that had been inserted (if typed over with underscoring) or deleted (if typed over with hyphens). As a result, it became possible for the reader to identify precisely what insertions and/or deletions have been made relative to a previous version of the document. As used herein, the process of flagging insertions and/or deletions may be referred to as “markup”, and the marked-up insertions and/or deletions themselves may be referred to as “revisions”.

Modern word processors enable the user to perform markup in a variety of different ways. For example, “blackline markup” may be performed by adding underline formatting to a string of characters (analogous to a series of underscores) and/or by adding strikethrough formatting to the string of characters (analogous to a series of hyphens). The reformatting can typically be performed for any number of contiguous characters with a single keystroke or mouseclick, which is faster than manually typing underscores or hyphens on top of already-typed characters. Blackline markup can be performed by, for example, typing formatted text or by typing unformatted text, selecting a portion thereof, and formatting the selection.

Another kind of markup is “tracked markup”. When activated, the tracked markup feature will automatically track revisions in the document. The tracked markup feature in modern word processors echoes the conventions that that typists once followed, in which underlining is placed beneath inserted characters and strikethrough is placed over deleted characters. However, unlike blackline markup, the underlining or striking in tracked markup is performed automatically upon insertion or deletion, without the need to manually reformat.

Like the reader of the document with blackline markup, a reader of a document with tracked markup can easily identify revisions marked by underlining and strikethrough, and therefore understand precisely what changes have been made. Moreover, tracked markup may also automatically change the color of the underlined or struck text so as to better draw the reader's attention to the changes. Accordingly, insertions may appear as underlined text having a specific color, for example, red, blue, purple, etc. Deletions may appear as struck text, i.e., text with a line through a central portion of each character. The deletions may also have a specific color, which may be the same or different from the color of the insertions.

Compared to blackline markups, tracked markups are easier to type (since the underlining and/or striking is performed automatically) and better stand out (since the text has a different color). Moreover, many word processors have additional functionality related to tracked markups. For example, the user may be able to find and select the next revision, accept or reject a particular revision, accept or reject all revisions, etc.

Despite the many advantages of tracked changes, blackline markups are sometimes necessary. For example, when amending legal documents, tracked markups may not be permitted. In these scenarios, it may be necessary to indicate changes using blackline markups.

Currently, users seeking to create documents with blackline markup can not fully enjoy the advantages of tracked markup, i.e., reduced keystrokes and mouseclicks, coloring of revised text, etc. Accordingly, new word processing methods are necessary.

### SUMMARY

The following summary is an overview provided solely to aid in the description of various aspects of the disclosure and is provided solely for illustration of the aspects and not limitation thereof.

Aspects of this disclosure relate generally to word processing applications, and more particularly to toggling between tracked markup and blackline markup.

### BRIEF DESCRIPTION OF THE DRAWINGS

The accompanying drawings are presented to aid in the description of various aspects of the disclosure and are provided solely for illustration of the aspects and not limitation thereof.

FIG. 1A generally illustrates an example computer system.

FIG. 1B generally illustrates an example implementation of the enclosure depicted in FIG. 1A.

FIG. 2 generally illustrates a graphical user interface for a word processing application that may be installed on the computer system of FIG. 1.

FIG. 3 generally illustrates two varieties of markup that may be used by the word processing application of FIG. 2.

FIG. 4 generally illustrates an example toggling method for converting one variety of markup to the other variety of markup.

FIG. 5 generally illustrates an example method for the converting of each tracked markup in a toggling range to a blackline markup, as depicted in FIG. 4.

FIG. 6 generally illustrates an example method for the converting of each blackline markup in a toggling range to a tracked markup, as depicted in FIG. 4.

FIG. 7 generally illustrates an example method for identifying a text segment that is within the toggling range and comprises a single type of blackline markup, as depicted in FIG. 6.

FIG. 8 generally illustrates an example method for converting a text segment to an insertion-type revision, as depicted in FIG. 6.

FIG. 9 generally illustrates an example method for converting a text segment to a deletion-type revision, as depicted in FIG. 6.

### DETAILED DESCRIPTION

As noted above, some users of the word-processing application may be required to amend documents using blackline markup. Accordingly, new word processing methods are necessary to enable these users to fully enjoy the advantages of tracked markup.

In accordance with aspects of the present disclosure, a system and method are provided for rapidly toggling, with a single keystroke or mouseclick, between tracked markup and blackline markup. Accordingly, revisions made with the benefit of tracked markup can be quickly converted to blackline markup if blackline markup is required. Moreover, existing documents having blackline markup can be quickly converted to tracked markup, thus availing the user of all of the functions associated with tracked markup (for example, improved visibility, improved navigation from one revision to the next, and single-command acceptance and rejection of revisions, individually or in bulk).

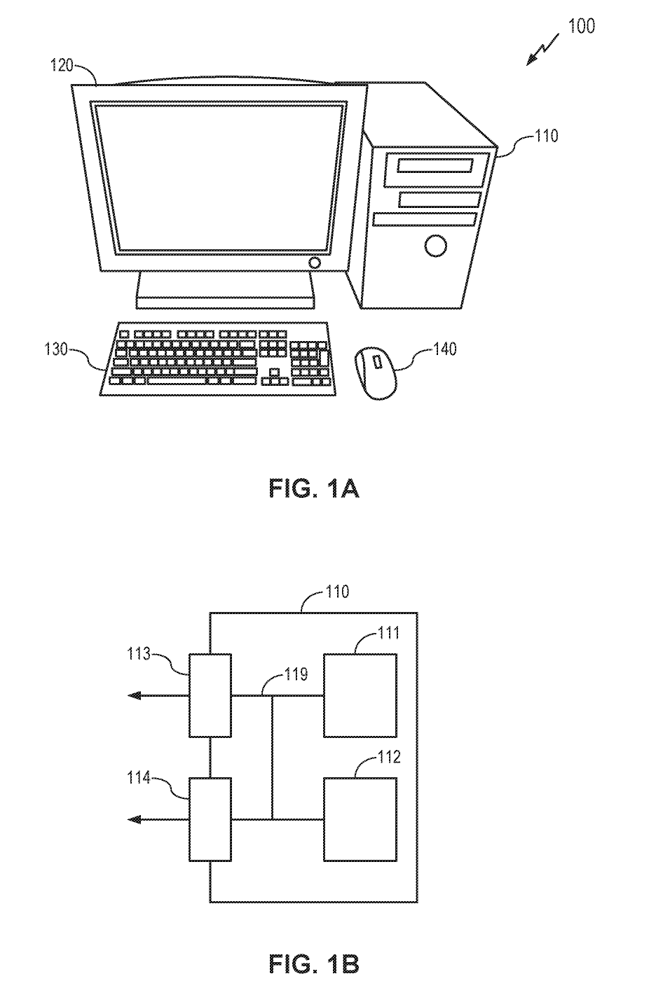

FIG. 1A generally illustrates an example computer system 100 having an enclosure 110 and FIG. 1B generally illustrates a detail of the enclosure 110 depicted in FIG. 1A. As shown in FIG. 1A, the computer system 100 may comprise the enclosure 110, a screen 120, a keyboard 130, and a mouse 140. The screen 120, the keyboard 130, and the mouse 140 may be referred to generally as “peripheral devices”.

As depicted in FIG. 1B the enclosure 110 may enclose hardware. The hardware may include memory 111, a processing system 112, one or more inputs 113, one or more outputs 114, and any other suitable components. The memory 111, the processing system 112, the one or more inputs 113, and the one or more outputs 114 may communicate via a bus 119. The memory 111 may include a computer readable medium, for example, a non-transitory computer readable medium. The memory 111 may be configured to store data and/or instructions. The processing system 112 may be configured to perform operations based on, for example, the data and/or instructions stored in the memory 111. The one or more inputs 113 may be wired or wireless, and may include inputs from one or more of the peripheral devices, inputs from other elements (for example, a network), or any other inputs of the computer system 100. The one or more outputs 114 may be wired or wireless, and may include outputs to one or more of the peripheral devices, outputs to other elements, or any other outputs of the computer system 100.

A user interacts with the computer system 100 via the one or more inputs 113 and the one or more outputs 114, which may be coupled to the screen 120, the keyboard 130, the mouse 140, and/or any other element. Each of the peripheral devices may serve as an input and/or an output of the computer system 100. For example, the screen 120 may be a touch screen that enables the user to input a command to the computer system 100 by tapping on a particular portion of the screen 120. The tapping may be converted to an electronic signal and communicated to the enclosure 110 via the one or more inputs 113. The screen 120 may also display an output (communicated via the one or more outputs 114) to the user, for example, text associated with a word processing application, email application, spreadsheet application, etc.

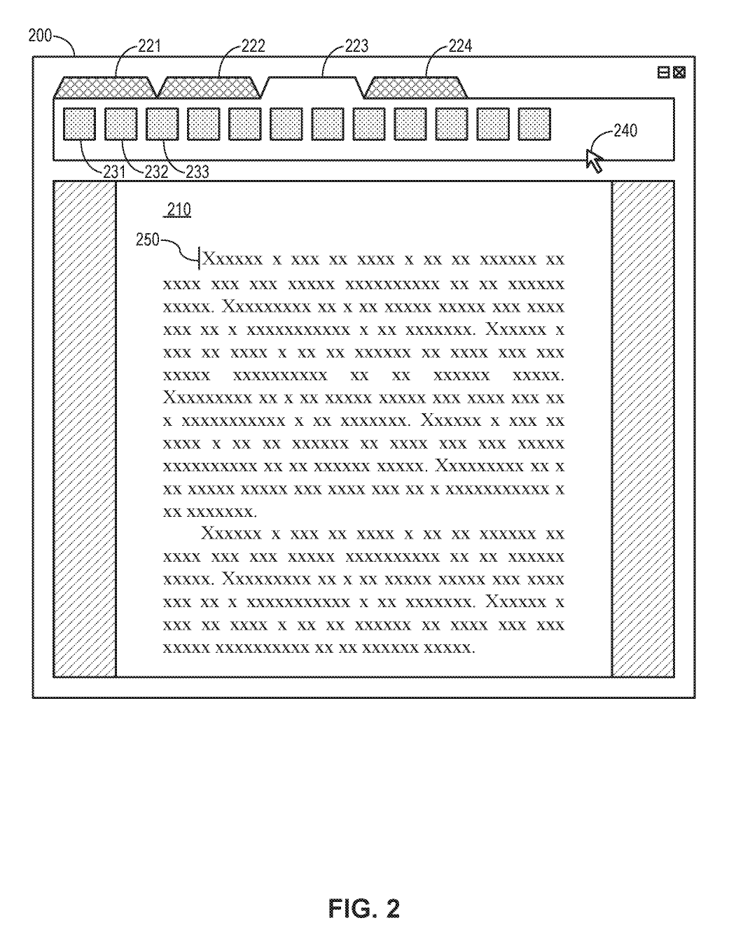

FIG. 2 generally illustrates a graphical user interface 200 for a word processing application. The word processing application may be stored in the memory 111, executed using the processing system 112, and/or displayed on the screen 120. As depicted in FIG. 2, the graphical user interface 200 may comprise a graphical representation of a document 210. The graphical user interface 200 may further comprise any number of tabs, for example, a first tab 221, a second tab 222, a third tab 223, and a fourth tab 224. Each tab may be associated with a ribbon that includes one or more command buttons, for example, a first command button 231, a second command button 232, and a third command button 233. A user of the word processing application may compose, edit, format, navigate, display, save, and/or print the document 210 by manipulating, for example, one or more of the one or more peripheral devices.

The user of the graphical user interface 200 may command the computer system 100 to perform various tasks using the screen 120, the keyboard 130, and/or the mouse 140. For example, if the screen 120 is a touch screen, the user may press a portion of the touch screen associated with, for example, the first command button 231. As another example, the user may stroke one or more keys on the keyboard 130. Each particular key or combination of keys may be associated with a particular command. As yet another example, the user may displace the mouse 140, thereby moving a pointer 240 around the graphical user interface 200. The pointer 240 can be placed over, for example, the first command button 231 through manipulation of the mouse 140. The mouse 140 can then be used to click the first command button 231 using one or more buttons on the mouse 140.

In the present disclosure, the term “keystroke” refers to any stroke of one or more keys on the keyboard 130 that signals a recognizable command to the computer system 100. The keyboard 130 may have multiple keys associated with any number of respective characters (letters, numbers, punctuation, etc.). In response to the pressing of a particular key, the associated character may be added to the document 210 and may appear on the graphical user interface 200. The graphical user interface 200 may include a cursor 250 that marks the place in the document 210 to which the character will be added. Some keys (for example, ‘Alt’, ‘Ctrl’, and ‘Shift’) may be used in combination with other keys to specify a particular command. For example, the user may press ‘Ctrl’ and, while holding the ‘Ctrl’ key, simultaneously press another key, for example, ‘S’. This keystroke is denoted ‘Ctrl+S’ and may be associated with a particular word-processor command (for example, ‘save document’). Accordingly, the term “keystroke” may correspond to any keystroke or simultaneous combination of keystrokes that signal a single particular word-processor command associated with the word processing application (for example, ‘X’, ‘Ctrl+S’, ‘Ctrl+Shift+M’, ‘F12’, etc.).

In the present disclosure, the term “mouseclick” refers to any stroke of a key on the mouse 140. The mouse 140 may have one or more buttons or wheels and any operation of a button or wheel may be referred to as a mouseclick. As an example, the user may indicate a particular word-processing command by selecting a particular tab (for example, the third tab 223 depicted in FIG. 2) with a first mouseclick and selecting a particular command button on the ribbon (for example, the first command button 231) with a second mouseclick. The first command button 231 may in turn be associated with a single particular word-processing command.

As used herein, the term “word-processing command” refers to a command that causes word processing to occur. The term “word-processing command” does not refer to commands that merely select a particular tab or open a command menu, thus enabling selection of one or more word-processing command (as described above). Instead, commands that facilitate selection of word-processing command may be referred to as “prerequisite commands”. It will be understood that in some scenarios, a prerequisite command may be necessary in order to enable selection of a word-processing command. However, in other scenarios (for example, if the third tab 223 is already open), no prerequisite commands are necessary.

There are many types of prerequisite commands that do not result in word processing. For example, a series of keystrokes and/or mouseclicks may be used to assign a particular word-processing command to a particular keystroke (for example, ‘Ctrl+M’ or ‘Ctrl+Shift+M’ may be assigned to the markup toggling command described in greater detail below). The process of assigning includes one or more prerequisite commands that open various assignment menus, but do not result in word-processing commands. Once the prerequisite commands have been received, however, the assigned keystroke (for example, ‘Ctrl+M’) may be used to execute the particular word-processing command to which the keystroke is assigned.

As another example, a click of a secondary button on the mouse 140 may open up a menu of selectable commands which may be selected by displacing the mouse 140 until the pointer 240 hovers over a particular word-processing command, and clicking the primary button. The click of the secondary button may trigger a prerequisite command that opens the menu of selectable commands, and the click of the primary button may trigger a word-processing command that instructs the computer system 100 to perform a single particular word-processing function.

Accordingly, the term “mouseclick” may refer to any click that signals a single particular word-processing command associated with the word processing application (for example, a click of the first command button 231 or selection of a specific command on a command menu), irrespective of whether or not one or more prerequisite commands were necessary to display and/or access the first command button 231 or the command menu.

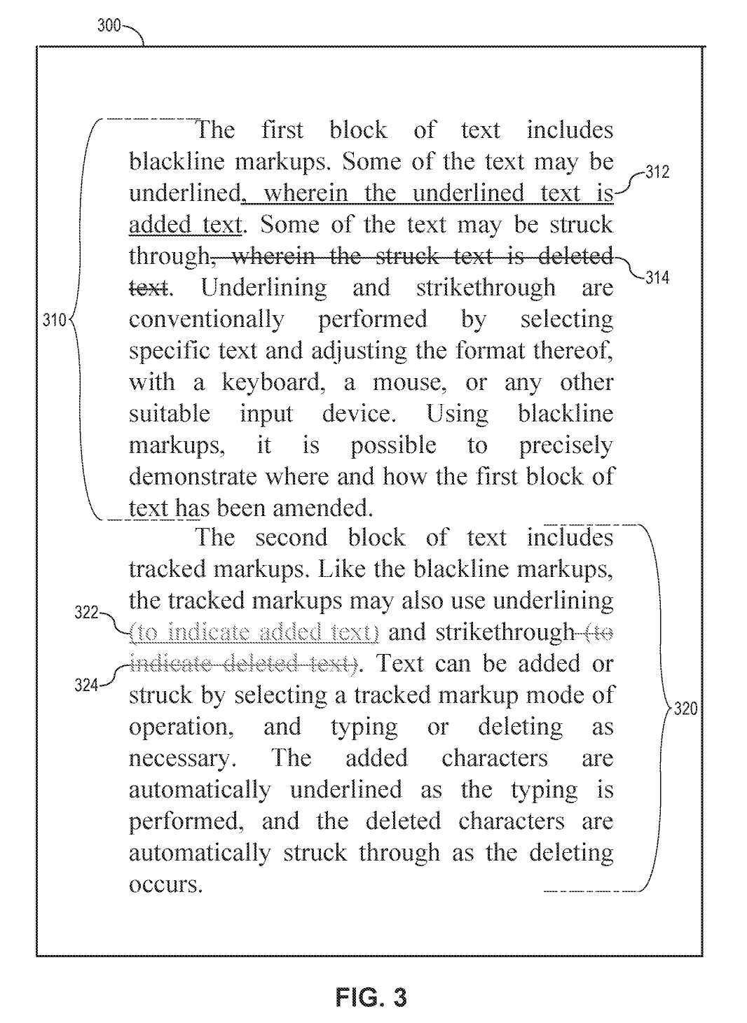

If the screen 120 is a touchscreen, then instead of clicking on a primary button with the pointer 240 using the mouse 140, the user may tap the primary button (or the place where the primary button appears on the screen 120) with an appendage (for example, a finger or stylus). Hovering one's finger over the primary button and tapping may have the same effect as hovering the pointer 240 over the primary button and clicking. FIG. 3 generally illustrates two varieties of markup that may be used by the word processing application of FIG. 2. As depicted in FIG. 3, a document 300 (analogous to the document 210 depicted on the graphical user interface 200 of FIG. 2) may include, for example, a first block of text 310 and a second block of text 320.

The first block of text 310 depicted in FIG. 3 includes blackline markups, including an insertion-type blackline markup 312 and a deletion-type blackline markup 314. The insertion-type blackline markup 312 may indicate that the text is inserted text. For example, a previous version of the document may not have included the inserted text, but the inserted text is provided in a present version. The deletion-type blackline markup 314 may indicate that the text is deleted text. For example, the previous version of the document may have included the deleted text.

The second block of text 320 includes tracked markups, including an insertion-type tracked markup 322 and a deletion-type tracked markup 324. The insertion-type tracked markup 322 may indicate that the text is inserted text. The deletion-type tracked markup 324 may indicate that the text is deleted text.

In some scenarios, the tracked markups may enable more efficient review of the document 300. Blackline markups are typically the same color as the surrounding text (for example, black or any other suitable color). In order to indicate text that has been inserted, the user may be required to, in some order, type the inserted text and change the format of the inserted text to underline. In order to indicate text that has been deleted, the user be required to select one or more characters intended for deletion and format the characters with strikethrough.

The tracked markups, by contrast, may be a different color than the surrounding text (for example, red, blue, or purple), thus making them easier to pick out at a glance. In addition, lines of text that include tracked markups may be indicated in the margin of the document 300 using, for example, a vertical line of a distinctive color that is aligned with the revisions. Some word processing applications have word-processing commands that instruct the computer system 100 to navigate to and/or select a nearest and/or next block of revised text (for example, the insertion-type tracked markup 322). Another command may instruct the computer system 100 to accept the revision, and yet another command may instruct the computer system 100 to reject the revision. If the insertion-type tracked markup 322 is accepted, the text may be reformatted such that the underlining is removed and the color reverts to the default color (for example, black). If the insertion-type tracked markup 322 is rejected, then each character in the insertion-type tracked markup 322 may be deleted. Similarly, acceptance or rejection of the deletion-type tracked markup 324 results in deletion of the struck text (in the case of acceptance) or elimination of the strikethrough formatting and distinctive coloring (in the case of rejection). Yet another command may instruct the computer system 100 to perform a mass acceptance or mass rejection of every revision within the selected text and/or every revision in the document 210. By accepting or rejecting each revision, the user can quickly generate a “clean” version of the document 300.

Few of the features associated with tracked markups are available to the user when using blackline markups. For example, generated a clean version of the document 300 requires a substantial number of mouseclicks and/or keystrokes, each associated with a different word-processing command, to seek out, find, and select the insertion-type blackline markup 312 or the deletion-type blackline markup 314. The commands may include find commands, select commands, etc. Then additional mouseclicks and/or keystrokes are required to delete the text (when rejecting an insertion or accepting a deletion) or remove the formatting (when accepting an insertion or rejecting a deletion).

As will be discussed in greater detail below, toggling methods are disclosed for converting tracked markup to blackline markup and/or vice-versa. The toggling methods enable a user that is obligated to use blackline markup to fully enjoy the advantages of tracked markup (improved visibility, rapid navigation, rapid acceptance/rejection, mass acceptance/rejection, etc.).

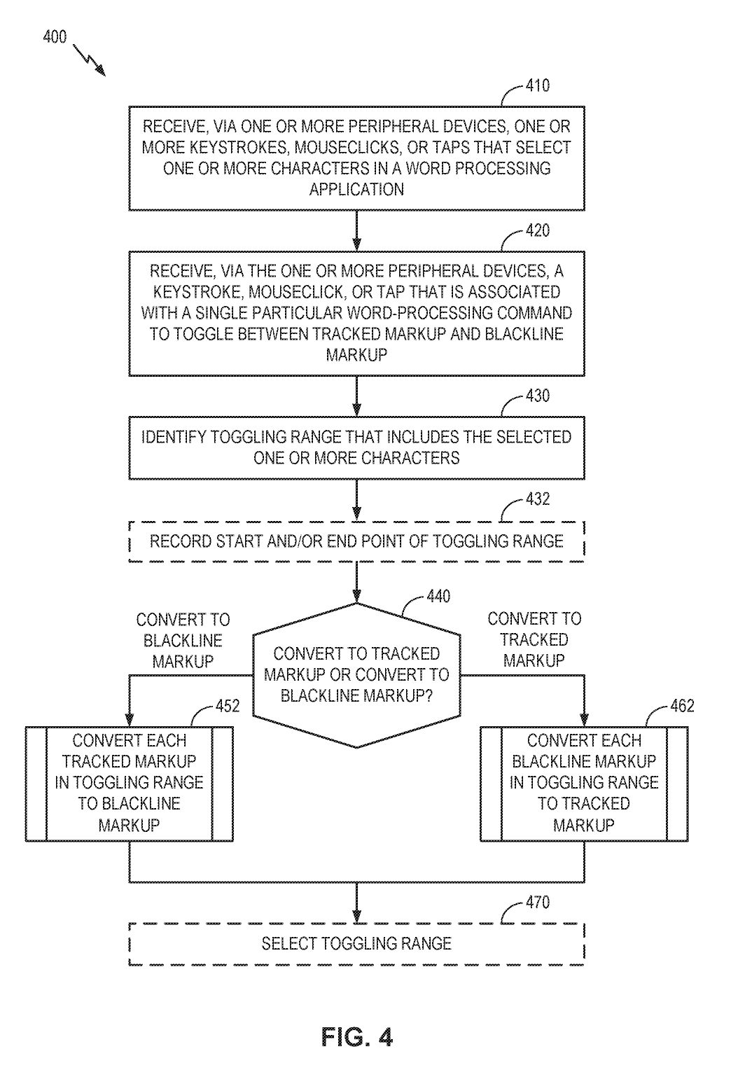

FIG. 4 generally illustrates an example toggling method 400 for converting one variety of markup to the other variety of markup. Each step of method 400 may be performed by the one or more processors and memory associated with the computer system 100.

At 410, the method 400 receives, via one or more peripheral devices, one or more keystrokes, mouseclicks, or taps that select one or more characters in a word processing application. The receiving at 410 may be performed by the processing system 112 and may be performed in tandem with the memory 111, the one or more inputs 113, the screen 120, the keyboard 130, the mouse 140, and/or any other suitable components. Accordingly, the processing system 112 and/or the components used in tandem may constitute means for receiving, via one or more peripheral devices, one or more keystrokes or mouseclicks that select one or more characters in a word processing application.

At 420, the method 400 receives, via one or more peripheral devices, a keystroke, mouseclick, or tap that is associated with a single particular word-processing command to toggle between tracked markup and blackline markup. The receiving at 420 may be performed by the processing system 112 and may be performed in tandem with the memory 111, the one or more inputs 113, the screen 120, the keyboard 130, the mouse 140, and/or any other suitable components. Accordingly, the processing system 112 and/or the components used in tandem may constitute means for receiving, via one or more peripheral devices, a keystroke or mouseclick that is associated with a command to toggle between tracked markup and blackline markup.

At 430, the method 400 identifies a toggling range that includes the selected one or more characters. The identifying at 420 may be performed by the processing system 112 and may be performed in tandem with the memory 111 and/or any other suitable components. Accordingly, the processing system 112 and/or the memory 111 may constitute means for identifying a toggling range that includes the selected one or more characters.

At 432, the method 400 optionally records a start point and/or an end point of the toggling range defined at 430. The recorded start point and/or end point may be recorded in the memory 111 as per the instructions of the processing system 112. Accordingly, the processing system 112 and/or the memory 111 may constitute means for recording a start point and/or an end point of the toggling range.

Additionally or alternatively, the optional recording 432 may comprise recording a tracked markup activation status. In one possible example, a boolean value is recorded, for example, set to ‘TRUE’ if the tracked markup is ‘activated’ and set to ‘FALSE’ if the tracked markup is ‘deactivated’. In some implementations, the tracked markup activation status may be set to ‘deactivated’ prior to continuance of the method 400, for example, immediately subsequent to the receiving 420, the defining 430, or the optional recording 432. Accordingly, the processing system 112 and/or the memory 111 may constitute means for recording a tracked markup activation status, and may further constitute means for setting the tracked markup activation status to a deactivated status.

At 440, the method 400 determines whether to convert the blackline markup in the toggling range to tracked markup or to convert the tracked markup in the toggling range to blackline markup. If the method 400 determines to convert each tracked markup to blackline markup (‘to blackline markup’ at 440), then the method 400 proceeds to 452. If the method 400 determines to convert each blackline markup to tracked markup (‘to tracked markup’ at 440), then the method 400 proceeds to 462. Accordingly, the processing system 112 and/or the memory 111 may constitute means for determining whether to convert the one or more characters in the toggling range to tracked markup or to convert the one or more characters in the toggling range to blackline markup.

The determining may be performed in any suitable manner. In one example, the method 400 determines whether the toggling range defined at 430 includes one or more tracked markups. If the toggling range includes one or more tracked markups, then the method 400 proceeds to 452. If the toggling range includes zero tracked markups, then the method 400 proceeds to 462. In another example, the method 400 may proceed to 452 if the method 400 proceeded to 462 in a previous iteration, and may proceed to 462 if the method 400 proceeded to 452 in a previous iteration. In yet another example, the method 400 may proceed to 452 if the first revision in the toggling range is a tracked markup, and may proceed to 462 if the first revision in the toggling range is a blackline markup.

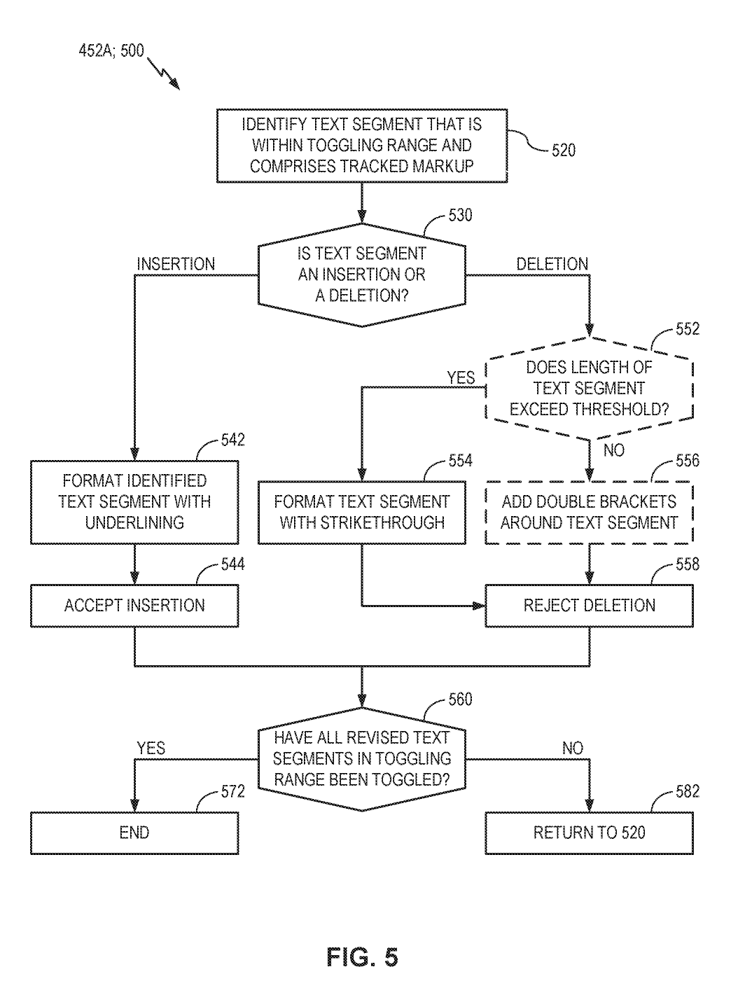

At 452, the method 400 converts each tracked markup in the toggling range to a blackline markup. The converting 452 may be performed using, for example, the method 500 described below in relation to FIG. 5. Accordingly, the processing system 112 and/or the memory 111 may constitute means for converting each tracked markup in the toggling range to a blackline markup.

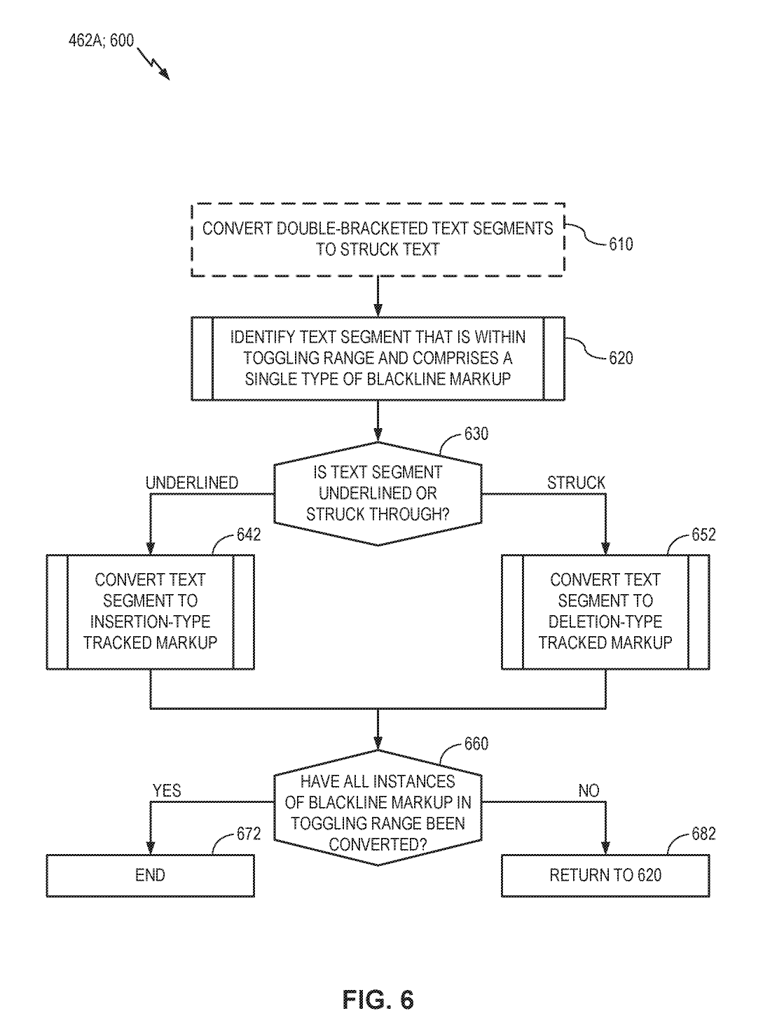

At 462, the method 400 converts each blackline markup in the toggling range to a tracked markup. The converting 462 may be performed using, for example, the method 600 described below in relation to FIG. 6. Accordingly, the processing system 112 and/or the memory 111 may constitute means for converting each blackline markup in the toggling range to a tracked markup.

At 470, the method 400 optionally selects the toggling range identified at 430 and/or recorded at 432. As a result, the one or more characters that the user selected at 410 will appear to have remained selected after the completion of the method 400. Additionally or alternatively, the optional selecting 470 may comprise setting the tracked markup activation status, for example, ‘activated’ or ‘deactivated’, to the tracked markup activation status recorded at 432. Accordingly, the processing system 112 and/or the memory 111 may constitute means for selecting the toggling range. After 470, the method 400 may terminate.

It will be understood that the receiving 410 and the receiving 420 may be performed in tandem with one or more peripheral devices, and may require manipulation by the user of the one or more peripheral devices. However, the defining 430, the optional recording 432, the converting 440, the converting 452, the converting 462, and the optional selecting 470 may be performed automatically and in their entireties by the computer system 100—responsive to the receiving at 420, but without any input from the user and without any manipulation by the user of the one or more peripheral devices. The method 400 may enable the user to toggle the markup within a text selection much more quickly than prior art approaches would permit.

FIG. 5 generally illustrates an example method 500 for implementing the converting at 452 of each tracked markup in a toggling range to a blackline markup. Accordingly, the method 500 may be performed immediately subsequent to the determining at 440 and/or immediately prior to the selecting at 470. Because the method 500 is an example implementation of the converting at 452 depicted in FIG. 4, it may also be referred to as 452A. Moreover, the processing system 112 and/or the memory 111 may constitute means for performing one or more of the tasks in the example method 500.

At 520, the method 500 identifies a text segment that includes one or more characters within the toggling range and comprises tracked markup, for example, insertion-type tracked markup 322 or deletion-type tracked markup 324. In some implementations, the identified text segment may only include a portion of the tracked markup that is wholly contained within the toggling range. In other implementations, the identified text segment may include the portion of the tracked markup that is wholly contained within the toggling range, as well as any characters that are the same type of tracked markup and contiguous with the portion of the tracked markup that is wholly contained within the toggling range.

At 530, the method 500 determines whether the text segment is an insertion-type tracked markup (analogous to the insertion-type tracked markup 322) or a deletion-type tracked markup (analogous to the deletion-type tracked markup 324). If the text segment is an insertion-type tracked markup (‘insertion’ at 530), then the method 500 proceeds to 542. If the text segment is a deletion-type tracked markup (‘deletion’ at 530), then the method 500 proceeds to 552.

At 542, the method 500 formats the text segment identified at 520 with underlining. For example, an underline status of the text segment may be set to ‘single underline’. At 544, the method 500 accepts the insertion and proceeds to 560. The formatting at 542 and the acceptance at 544 may be performed in any order.

At 552, the method 500 optionally determines if the length of the text segment is greater than a threshold. If the length of the text segment exceeds the threshold (‘yes’ at 552), then the method 500 proceeds to 554. If the length of the text segment does not exceed the threshold (‘no’ at 552), then the method 500 proceeds to 556.

At 554, the method 500 formats the text segment with strikethrough and then proceeds to 558. For example, a strikethrough status of the text segment may be set to ‘single strikethrough’.

At 556, the method 500 adds double brackets around the text segment and then proceeds to 558. For example, the method 500 may add a pair of open brackets ‘[[’ to the beginning of the text segment and may add a pair of closed brackets ‘]]’ to the end of the text segment.

At 558, the method 500 rejects the deletion and proceeds to 560. The formatting at 554 or adding at 556 and the rejection at 558 may be performed in any order.

As will be understood from FIG. 5, the determining at 552 and the adding at 556 are optional. In some implementations of blackline markup, double brackets are used as an alternative to strikethrough for text segments that are less than a certain length. For example, if the text segment has five or fewer characters, the user may be required to indicate a deletion by inserting double brackets instead of formatting with strikethrough. If double brackets are not required and/or the user prefers not to use double brackets, then the determining at 552 and the adding at 556 may be omitted and the method 500 may proceed from 530 directly to 554.

At 560, the method 500 determines whether all revised text segments in the toggling range have been converted to blackline markup. If all the revisions have been converted to blackline markup (‘yes’ at 560), the method 500 proceeds to 572, where the method 500 ends. If there are still revisions in the toggling range that have not been converted to blackline markup (‘no’ at 560), the method 500 proceeds to 582, where the method 500 returns to the identifying at 520.

The determining at 560 may be performed in any suitable manner. For example, the method 500 may initialize by counting the total number of revisions (N_{T}) and/or storing the N_{T} value. Then the determining at 560 may continually return to 520 until the returning has been performed (N_{T}−1) times. As another example, the method 500 may count the number of remaining revisions (N_{R}), and may return to 520 in response to a determination that N_{R} is greater than zero.

FIG. 6 generally illustrates an example method 600 for implementing the converting at 462 of each blackline markup in a toggling range to a tracked markup. Accordingly, the method 600 may be performed subsequent to the determining at 440 and prior to the selecting at 470. Because the method 600 is an example implementation of the converting at 462 depicted in FIG. 4, it may also be referred to as 462A. Moreover, the processing system 112 and/or the memory 111 may constitute means for performing one or more of the tasks in the example method 600.

At 610, the method 600 optionally converts double-bracketed text segments to struck text. As noted above, in some implementation of blackline markup, double-brackets are used as an alternative to strikethrough.

The double brackets may be preferable for small revisions, for example, the striking of five or fewer characters. When striking a string of characters, the user may add two open brackets ‘[[’ to the front of the string and two closed brackets ‘]]’ to the end of the string. In some implementations, the method 600 may be configured to find double-bracketed characters, and convert (at 610) the double-bracketed text. For example, the method 600 may search the toggling range for a pair of open brackets ‘[[’ and then determine if a pair of closed brackets ‘]]’ follows the pair of open brackets. In some implementations, the pair of closed brackets must follow and be within a certain distance of the pair of open brackets, for example, separated by five or fewer characters. Once located, both pairs of double brackets may be deleted and the characters within may be formatted with strikethrough.

At 620, the method 600 identifies a text segment that is within the toggling range and comprises a single type of blackline markup. In some implementations, a text segment that comprises a single type of blackline markup is “within the toggling range” if an entirety of the text segment is within the toggling range. In other implementations, if any part of the text segment is within the toggling range, then the entirety of the text segment is selected, even if part of it is outside the toggling range.

At 630, the method 600 determines whether the text segment is underlined or struck through. If the method 600 determines that the text segment is underlined (‘underlined’ at 630), then the method 600 proceeds to 642. If the method 600 determines that the text segment is struck through (‘struck through’ at 630), then the method 600 proceeds to 652.

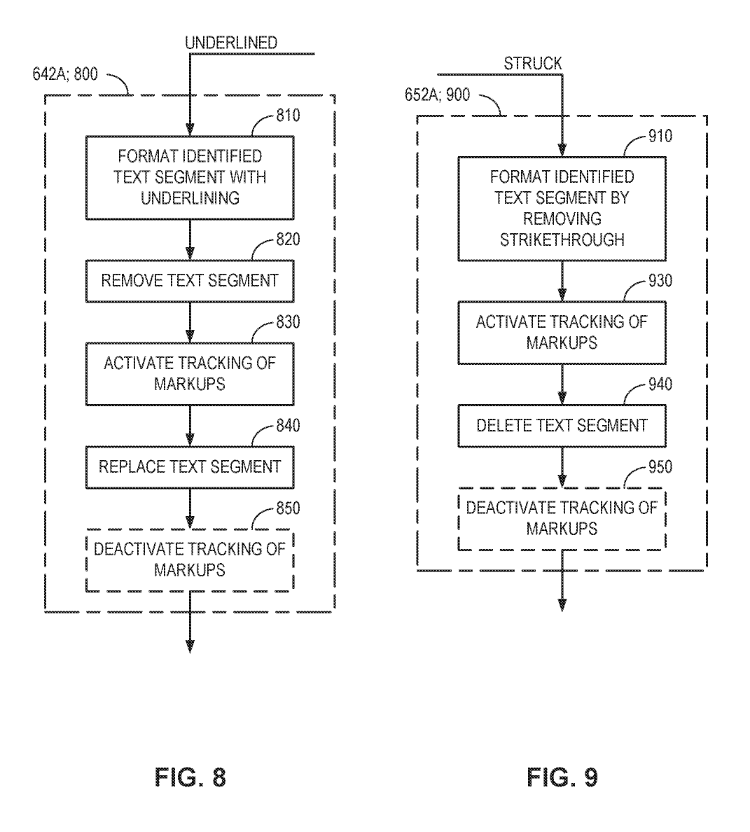

At 642, the method 600 converts the characters in the text segment to an insertion-type revision. In some implementations, the converting at 642 may be performed in accordance with the method 642A depicted in FIG. 8, as will be discussed in greater detail below. After the converting at 642 is complete, the method 600 may proceed to 660.

At 652, the method 600 converts the characters in the text segment to a deletion-type revision. In some implementations, the converting at 652 may be performed in accordance with the method 652A depicted in FIG. 9, as will be discussed in greater detail below. After the converting at 652 is complete, the method 600 may proceed to 660.

At 660, the method 600 determines whether all instances of blackline markup in the toggling range have been converted. If the 600 determines that all instances of blackline markup have been converted (‘yes’ at 660), then the method 600 proceeds to 672. If the method 600 determines that the toggling range still includes instances of blackline markup (‘no’ at 660), then the method 600 proceeds to 682. At 672, the method 600 ends.

At 682, the method 600 returns to 620. Upon returning to 620, the method 600 identifies a new text segment and converts it. In some implementations, the initial toggling range (identified, for example, at 430) may be shortened in order to speed up the process. Accordingly, the identifying at 620 may be performed within a shortened toggling range. For example, the initial toggling range and the shortened toggling range may co-terminate, but the starting point of the shortened toggling range may be advanced relative to the starting point of the initial toggling range. In particular, if the method 600 determines that the first fifty characters in the initial toggling range are unrevised characters (formatted with neither underlining nor strikethrough), then the fifty-first character may be selected as the beginning of the shortened toggling range. Each time an instance of blackline markup is converted, the number of leading unrevised characters may increase, and the beginning of the shortened toggling range may advance correspondingly (for example, to the end of the just-converted text segment).

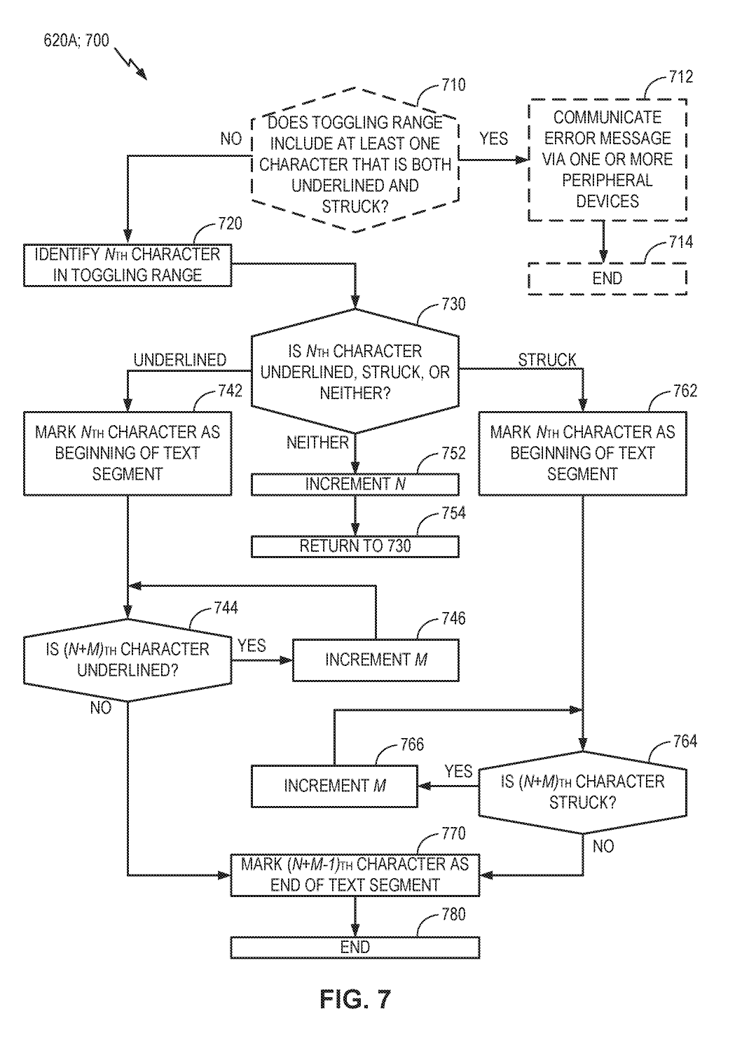

FIG. 7 generally illustrates an example method for implementing the identifying at 620 of a text segment that is within the toggling range and comprises a single type of blackline markup. Accordingly, the method 700 may be performed immediately subsequent to the optional converting at 610 and/or immediately prior to the determining at 630. Because the method 700 is an example implementation of the identifying at 620 depicted in FIG. 6, it may also be referred to as 620A. Moreover, the processing system 112 and/or the memory 111 may constitute means for performing one or more of the tasks in the example method 700.

At 710, the method 700 optionally determines whether the toggling range includes at least one character that is formatted with both underlining and strikethrough. If the method 700 determines that the toggling range includes at least one character that is formatted with both underlining and strikethrough (‘yes’ at 710), then the method 700 proceeds to 720. If the method 700 determines that the toggling range does not include at least one character that is formatted with both underlining and strikethrough (‘no’ at 710), then the method proceeds to 730.

At 712, the method 700 optionally communicates an error message via one or more peripheral devices. For example, the screen 120 may display a message explaining that the toggling range includes an ambiguous revision and that the conversion has been aborted. At 714, the method 700 terminates. More broadly, the method 400 and/or the method 600 may also terminate subsequent to communication of the error message.

It will be understood that if the optional determining at 710, the optional communicating at 712, and the ending at 714 are not performed, then the method 700 may begin at 720.

At 720, the method 700 identifies the N^{th} character in the toggling range. The toggling range may refer to the initial toggling range identified at 430 and/or the shortened toggling range described above. The value of N may initially be zero (or one), and may increment as the method 700 proceeds character-by-character, as will be discussed in greater detail below.

At 730, the method 700 determines whether the N^{th} character is underlined, struck, or neither. If the method 700 determines that the N^{th} character is underlined (‘underlined’ at 730), then the method 700 proceeds to 742. If the method 700 determines that the N^{th} character is neither underlined nor struck (‘neither’ at 730), then the method 700 proceeds to 752. If the method 700 determines that the N^{th} character is struck (‘struck’ at 730), then the method 700 proceeds to 762.

At 742, the method 700 marks the N^{th} character as the beginning of the text segment. As noted above, the method 700 is performed in order to identify a text segment that is within the toggling range and comprises a single type of blackline markup. The identifying may consist of identifying the beginning of the text segment and identifying the end of the text segment, wherein identification of the beginning is completed at 742. In some implementations, the marking at 742 may comprise recording the value of N or the location of the N^{th} character (in, for example, the memory 111).

At 744, the method 700 determines whether the (N+M)^{th} character is underlined. The value of M may initialize at 1 and increment or reset as set forth below. If the method 700 determines that the (N+M)^{th} character is underlined (‘yes’ at 744), then the method 700 proceeds to 746. If the method 700 determines that the (N+M)^{th} character is not underlined (‘no’ at 744) then the method proceeds to 770.

At 746, the method increments the value of M and returns to 744. At 770, the method marks the (N+M−1)^{th} character as the end of the text segment. In some implementations, the marking at 770 may comprise recording the value of (N+M−1) or a location of the (N+M−1)^{th} character (in, for example, the memory 111).

It will be recalled that the method 700 proceeds to 752 in the event that the N^{th} character is neither underlined nor struck (‘neither’ at 730). At 752, the method 700 increments the value of N. At 754, the method 700 returns to 730 to determine once again whether the N^{th} character is underlined, struck, or neither. It will be understood that the value of N will continue to increment at 752 until revised text is found, at which point the beginning of the text segment has been identified.

It will be recalled that the method 700 proceeds to 762 in the event that the N^{th} character is struck (‘struck’ at 730). At 762, analogous to the marking at 742, the method 700 marks the N^{th} character as the beginning of the text segment. As noted above, the method 700 is performed in order to identify a text segment that is within the toggling range and comprises a single type of blackline markup. The identifying may consist of identifying the beginning of the text segment and identifying the end of the text segment, wherein identification of the beginning is completed at 762. In some implementations, the marking at 762 may comprise recording the value of N or the location of the N^{th} character (in, for example, the memory 111).

At 764, the method 700 determines whether the (N+M)^{th} character is struck. The value of M may initialize at one and increment or reset as set forth below. If the method 700 determines that the (N+M)^{th} character is struck (‘yes’ at 764), then the method 700 proceeds to 766. If the method 700 determines that the (N+M)^{th} character is not struck (‘no’ at 764) then the method proceeds to 770. At 766, analogous to the incrementing at 746, the method increments the value of M and returns to 764.

At 770, as already described above, the method marks the (N+M−1)^{th} character as the end of the text segment. In some implementations, the marking at 770 may comprise recording the value of (N+M−1) or a location of the (N+M−1)^{th} character (in, for example, the memory 111). At 780, the method 700 ends.

As an example of the identifying performed at 620A1700, suppose that the first block of text 310 depicted in FIG. 3 is selected (as at 410) and identified as the toggling range (as at 430). The method 620A may start at the beginning of the first block of text 310 (corresponding to, for example, N=0) and may proceed character-by-character (while incrementing N) until a revised character has been identified. In this example, the first revised character happens to be the first character of the insertion-type blackline markup 312 (the comma on line three). The method 620A may mark the location of the first revised character and identify that location as the beginning of the text segment. The method 620A may then identify the type of revision associated with the first revised character (in this case, insertion-type), and proceed character-by-character until an unrevised character is reached, or until a revised character of a different type (i.e., deletion type) is reached. The method 620A may mark the location of the last character having the same revision type as the first character (the second ‘t’ in line four, at the end of the word ‘text’) and identify that location as the end of the text segment.

Alternatively, the method 620A may consider other factors when identifying the end of the text segment. For example, the method 600 may proceed character-by-character until an unrevised or differently-revised character is reached, as noted above. However, the method 620A may also stop proceeding and mark the end of the text segment in response to a determination that the end of the toggling range has been reached. For example, if (N+M) is equal to the length of the toggling range, then (N+M) may be identified as the end of the text segment.

FIG. 8 generally illustrates an example method for implementing the converting at 642 of an identified text segment to an insertion-type tracked markup, as depicted in FIG. 6. Accordingly, the method 800 may be performed immediately subsequent to the determining at 630 and/or immediately prior to the determining at 660. Because the method 800 is an example implementation of the converting at 642 depicted in FIG. 6, it may also be referred to as 642A. Moreover, the processing system 112 and/or the memory 111 may constitute means for performing one or more of the tasks in the example method 800.

At 810, the method 800 formats the identified text segment with underlining. The formatting at 810 may comprise removal of the underlining. As noted above, the text segment may be identified by its beginning and its end. In accordance with the example implementation of FIG. 7, the text segment may include the N^{th} character, the (N+M−1)^{th} character, and every character in between. At 820, the method 800 removes the text segment. The removing may be performed using, for example, a ‘cut’ command.

At 830, the method 800 activates tracking of markups. As noted above, in some implementations of the method 400, the activation status of the tracked markup feature may be recorded and then set to ‘deactivated’ prior to conversion of the text segment. The activating at 830 set the activation status of the tracked markup feature to ‘activated’ prior to proceeding to 840.

At 840, the method 800 replaces the text segment. The replacing may be performed using, for example, a ‘paste’ command. The text segment may be replaced in the same location from which it was removed at 820. Because the activation status of the tracked markup feature is set to ‘activated’ prior to proceeding to 840, the blackline markup will be replaced by an insertion-type tracked markup analogous to the insertion-type tracked markup 322.

At 850, the method 800 optionally deactivates the tracking of markup, for example, by setting the activation status of the tracked markup feature to ‘deactivated’. Upon the completion of 850, the method 800 is complete, and the method 600 depicted in FIG. 6 may proceed to the determining at 660.

FIG. 9 generally illustrates an example method for implementing the converting at 652 of an identified text segment to a deletion-type tracked markup, as depicted in FIG. 6. Accordingly, the method 900 may be performed immediately subsequent to the determining at 630 and/or immediately prior to the determining at 660. Because the method 900 is an example implementation of the converting at 652 depicted in FIG. 6, it may also be referred to as 652A. Moreover, the processing system 112 and/or the memory 111 may constitute means for performing one or more of the tasks in the example method 900.

At 910, the method 900 formats the identified text segment by removing strikethrough. As noted above, the text segment may be identified by its beginning and its end. In accordance with the example implementation of FIG. 7, the text segment may include the N^{th} character, the (N+M−1)^{th} character, and every character in between.

At 930, the method 900 activates tracking of markups. As noted above, in some implementations of the method 400, the activation status of the tracked markup feature may be recorded and then set to ‘deactivated’ prior to conversion of the text segment. The activating at 930 set the activation status of the tracked markup feature to ‘activated’ prior to proceeding to 940.

At 940, the method 900 deletes the text segment. The deleting may be performed using, for example, a ‘delete’ command. Because the activation status of the tracked markup feature is set to ‘activated’ prior to proceeding to 940, the blackline markup will be replaced by a deletion-type tracked markup analogous to the deletion-type tracked markup 324.

At 950, the method 900 optionally deactivates the tracking of markup, for example, by setting the activation status of the tracked markup feature to ‘deactivated’. Upon the completion of 950, the method 900 is complete, and the method 600 depicted in FIG. 6 may proceed to the determining at 660.

The terminology used herein is for the purpose of describing particular embodiments only and not to limit any embodiments disclosed herein. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. Similarly, the phrase “based on” as used herein does not necessarily preclude influence of other factors and should be interpreted in all cases as “based at least in part on” rather than, for example, “based solely on”.

It will be understood that terms such as “top” and “bottom”, “left” and “right”, “vertical” and “horizontal”, etc., are relative terms used strictly in relation to one another, and do not express or imply any relation with respect to gravity, a manufacturing device used to manufacture the components described herein, or to some other device to which the components described herein are coupled, mounted, etc.

In some implementations, the various algorithms described above may be performed using a special-purpose computer that is configured to perform the various algorithms. For example, the computer system 100 may be a general-purpose computer which, when configured to perform one or more of the algorithms depicted in FIG. 4-9, becomes a special-purpose computer. The structure that performs the algorithm of FIG. 4 may comprise the memory 111, the processing system 112, and/or any other components (for example, peripheral devices) as set forth in the foregoing description.

Accordingly, each particular block in the methods depicted in FIGS. 4-9 may represent a module configured to perform the functionality specified in that particular block and/or described in the description thereof. The functionality of these modules may be implemented in various ways consistent with the teachings herein. In some designs, the functionality of these modules may be implemented as one or more electrical components. In some designs, the functionality of these modules may be implemented using a processing system including one or more processor components analogous to the processing system 112. In some designs, the functionality of these modules may be implemented using, for example, at least a portion of one or more integrated circuits (e.g., an ASIC). As discussed herein, an integrated circuit may include a processor, software, other related components, or any combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 7, as well as other components and functions described herein, may be implemented using any suitable means. Such means also may be implemented, at least in part, using corresponding structure as taught herein, for example, one or more of processor components, integrated circuits, or other suitable structures.

The blocks depicted in FIGS. 4-9 may correspond to similarly designated “code for” functionality. The code may be stored on, for example, a non-transitory computer-readable medium and may comprise at least one instruction for causing a processor to perform operations associated with the methods depicted in FIGS. 4-9.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not imply that there are only two elements and further does not imply that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements (AB, AC, BC, or ABC).”

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support general functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of non-transitory storage medium known in the art. As used herein the term “non-transitory” does not exclude any physical storage medium or memory and particularly does not exclude dynamic memory (e.g., RAM) but rather excludes only the interpretation that the medium can be construed as a transitory propagating signal. An example storage medium is coupled to the processor such that the processor can read information from, and write information to, the storage medium. In the alternative, the storage medium may be integral to the processor (e.g., cache memory).

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method, comprising:
receiving one or more first user input signals that signify selection of one or more characters associated with a word processing application;
receiving a second user input signal that signifies conversion of blackline markup to tracked markup;
identifying a toggling range that includes the selected one or more characters in response to the receiving of the second user input signal; and
converting a blackline markup within the toggle range to a corresponding tracked markup in response to the receiving of the second user input signal, wherein the converting comprises:
identifying a beginning of the blackline markup, wherein the identifying of the beginning comprises:
identifying an N^{th} character within the toggling range;
determining whether the N^{th} character is underlined and whether the N^{th} character is struckthrough;
incrementing N in response to a determination that the N^{th} character is not underlined and a determination that the N^{th} character is not struckthrough; and
marking the N^{th} character as a beginning of a blackline markup in response to a determination that the N^{th} character is underlined or that the N^{th} character is struckthrough;
identifying an end of the blackline markup, wherein the identifying of the end comprises:
identifying an (N+M)^{th} character within the toggling range, wherein M is initially set equal to one, in response to the determination that the Nth character is underlined or that the Nth character is struckthrough;
incrementing M in response to the determination that the N^{th} character is underlined and a determination that the (N+M)^{th} character is also underlined;
marking the (N+M−1)^{th} character as an end of the blackline markup in response to the determination that the N^{th} character is underlined and a determination that the (N+M)^{th} character is not underlined;
incrementing M in response to the determination that the N^{th} character is struckthrough and a determination that the (N+M)^{th} character is also struckthrough; and
marking the (N+M−1)^{th} character as the end of the blackline markup in response to the determination that the N^{th} character is struckthrough and a determination that the (N+M)^{th} character is not struckthrough;
determining whether the blackline markup includes underlining or strikethrough;
in response to a determination that the blackline markup is underlined:
formatting the one or more characters in the blackline markup to remove the underlining;
removing the one or more characters in the blackline markup from the toggling range;
activating tracking of markups such that an insertion or deletion of one or more characters will be recognized by the word processing application as a revision; and
replacing the one or more characters in the blackline markup to the toggling range;
in response to a determination that the blackline markup is struckthrough:
format the one or more characters in the blackline markup to remove the strikethrough;
activate tracking of markups such that an insertion or deletion of one or more characters will be recognized by the word processing application as a revision; and
delete the one or more characters in the blackline markup from the toggling range.

2. A method, comprising:
receiving one or more first user input signals that signify selection of one or more characters associated with a word processing application;
receiving a second user input signal that signifies conversion of blackline markup to tracked markup;
identifying a toggling range that includes the selected one or more characters in response to the receiving of the second user input signal; and
converting a blackline markup within the toggle range to a corresponding tracked markup in response to the receiving of the second user input signal.

3. The method of claim 2, wherein:
the second user input signal is received from a keyboard and the second user input signal is transmitted based on a single stroke of a single key on the keyboard or a simultaneous stroke of a plurality of keys on the keyboard;
the second user input signal is received from a mouse and the second user input signal is transmitted based on a single click of a software button or software menu item; or
the second user input signal is received from a touchscreen and the second user input is transmitted based on a single tap of a software button or software menu item.

4. The method of claim 2, wherein:
the blackline markup comprises an insertion-type blackline markup comprising one or more characters within the toggling range that are formatted with underlining, and the corresponding tracked markup comprises an insertion-type tracked markup comprising one or more characters within the toggling range, wherein the one or more characters are recognized by the word-processing application as a revision; or
the blackline markup comprises a deletion-type blackline markup comprising one or more characters within the toggling range that are formatted with strikethrough, and the corresponding tracked markup comprises a deletion-type tracked markup comprising one or more characters within the toggling range, wherein the one or more characters are recognized by the word-processing application as a revision.

5. The method of claim 4, further comprising:
receiving, from the one or more peripheral devices, a third user input signal that signifies acceptance or rejection of the corresponding tracked markup;
eliminating underline formatting, strikethrough formatting, distinctive coloring, or any combination thereof in response to the receiving of the third user input signal; and
terminating recognition by the word-processing application of the corresponding tracked markup as the revision.

6. The method of claim 2, wherein the converting comprises identifying a beginning of the blackline markup, wherein the identifying of the beginning comprises:
identifying an N^{th} character within the toggling range;
determining whether the N^{th} character is underlined and whether the N^{th} character is struckthrough;
incrementing N in response to a determination that the N^{th} character is not underlined and a determination that the N^{th} character is not struckthrough; and
marking the N^{th} character as a beginning of a blackline markup in response to a determination that the N^{th} character is underlined or that the N^{th} character is struckthrough.

7. The method of claim 6, wherein the converting further comprises identifying an end of the blackline markup, wherein the identifying of the end comprises:
identifying an (N+M)^{th} character within the toggling range, wherein M is initially set equal to one, in response to the determination that the Nth character is underlined or that the Nth character is struckthrough;
incrementing M in response to the determination that the N^{th} character is underlined and a determination that the (N+M)^{th} character is also underlined;
marking the (N+M−1)^{th} character as an end of the blackline markup in response to the determination that the N^{th} character is underlined and a determination that the (N+M)^{th} character is not underlined;
incrementing M in response to the determination that the N^{th} character is struckthrough and a determination that the (N+M)^{th} character is also struckthrough; and
marking the (N+M−1)^{th} character as the end of the blackline markup in response to the determination that the N^{th} character is struckthrough and a determination that the (N+M)^{th} character is not struckthrough.

8. The method of claim 2, wherein the converting comprises determining whether the blackline markup is underlined or struckthrough, and in response to a determination that the blackline markup is underlined:
formatting the one or more characters in the blackline markup to remove the underlining;
removing the one or more characters in the blackline markup from the toggling range;
activating tracking of markups such that an insertion or deletion of one or more characters will be recognized by the word processing application as a revision; and
replacing the one or more characters in the blackline markup to the toggling range.

9. The method of claim 2, wherein the converting comprises determining whether the blackline markup is underlined or struckthrough, and in response to a determination that the blackline markup is struckthrough:
formatting the one or more characters in the blackline markup to remove the strikethrough;
activating tracking of markups such that an insertion or deletion of one or more characters will be recognized by the word processing application as a revision; and
deleting the one or more characters in the blackline markup from the toggling range.

10. The method of claim 2, wherein the converting comprises:
determining whether tracked markup is activated at the time the second user input signal is received;
recording the determined activation status;
setting the activation status to deactivated;
formatting one or more characters in the blackline markup;
setting the activation status to activated;
replacing or delete one or more characters in the blackline markup; and
setting the activation status to the recorded activation status.

11. The method of claim 2, wherein the converting comprises:
determining that the selected one or more characters in the toggling range includes a first pair of consecutive characters consisting of two open brackets;
in response to the determination that the toggling range includes the two open brackets, determining that:
the selected one or more characters in the toggling range includes a second pair of consecutive characters consisting of two closed brackets; and
a number of characters between the two open brackets and the two closed brackets does not exceed a predetermined number of characters;
in response to the determinations that the toggling range includes the two closed brackets and that the predetermined number of characters is not exceeded:
identifying the characters between the two open brackets and the two closed brackets as the blackline markup;
deleting the two open brackets and the two closed brackets; and
formatting the blackline markup with strikethrough.

12. The method of claim 2, wherein the converting comprises:
determining whether the toggling range includes one or more tracked markups; and
converting a tracked markup within the toggle range to a corresponding blackline markup in response to a determination that the toggling range includes one or more tracked markups;
wherein the converting of the blackline markup comprises converting the blackline markup to the corresponding tracked markup in response to a determination that the toggling range includes zero tracked markups.

13. An apparatus, comprising:
one or more peripheral devices configured to:
receive a user input from a user, wherein the user input comprises a keystroke, a mouseclick, a touchscreen tap, or any combination thereof and
transmit a user input signal based on the user input;
a processor configured to:
receive, from the one or more peripheral devices, one or more first user input signals that signify selection of one or more characters associated with a word processing application;
receive, from the one or more peripheral devices, a second user input signal that signifies conversion of blackline markup to tracked markup;
identify a toggling range that includes the selected one or more characters in response to the receiving of the second user input signal; and
convert a blackline markup within the toggle range to a corresponding tracked markup in response to the receiving of the second user input signal; and
memory coupled to the processor and configured to store data, instructions, or a combination thereof.

14. The apparatus of claim 13, wherein:
the one or more peripheral devices comprise a keyboard and the second user input signal is transmitted based on a single stroke of a single key on the keyboard or a simultaneous stroke of a plurality of keys on the keyboard;
the one or more peripheral devices comprise a mouse and the second user input signal is transmitted based on a single click of a software button or software menu item; or
the one or more peripheral devices comprise a touchscreen and the second user input is transmitted based on a single tap of a software button or software menu item.

15. The apparatus of claim 13, wherein:
the blackline markup comprises an insertion-type blackline markup comprising one or more characters within the toggling range that are formatted with underlining, and the corresponding tracked markup comprises an insertion-type tracked markup comprising one or more characters within the toggling range, wherein the one or more characters are recognized by the word-processing application as a revision; or
the blackline markup comprises a deletion-type blackline markup comprising one or more characters within the toggling range that are formatted with strikethrough, and the corresponding tracked markup comprises a deletion-type tracked markup comprising one or more characters within the toggling range, wherein the one or more characters are recognized by the word-processing application as a revision.

16. The apparatus of claim 13, wherein to convert the blackline markup within the toggle range to the corresponding tracked markup, the processor is further configured to:
identify an N^{th} character within the toggling range;
determine whether the N^{th} character is underlined and whether the N^{th} character is struckthrough;
increment N in response to a determination that the N^{th} character is not underlined and a determination that the N^{th} character is not struckthrough; and
mark the N^{th} character as a beginning of a blackline markup in response to a determination that the N^{th} character is underlined or that the N^{th} character is struckthrough.

17. The apparatus of claim 16, wherein to convert the blackline markup, the processor is further configured to:
identify an (N+M)^{th} character within the toggling range, wherein M is initially set equal to one, in response to the determination that the Nth character is underlined or that the Nth character is struckthrough;
increment M in response to the determination that the N^{th} character is underlined and a determination that the (N+M)^{th} character is also underlined;
mark the (N+M−1)^{th} character as an end of the blackline markup in response to the determination that the N^{th} character is underlined and a determination that the (N+M)^{th} character is not underlined;
increment M in response to the determination that the N^{th} character is struckthrough and a determination that the (N+M)^{th} character is also struckthrough; and
mark the (N+M−1)^{th} character as the end of the blackline markup in response to the determination that the N^{th} character is struckthrough and a determination that the (N+M)^{th} character is not struckthrough.

18. The apparatus of claim 13, wherein to convert the blackline markup, the processor is further configured to determine whether the blackline markup is underlined or struckthrough, and in response to a determination that the blackline markup is underlined:
format the one or more characters in the blackline markup to remove the underlining;
remove the one or more characters in the blackline markup from the toggling range;
activate tracking of markups such that an insertion or deletion of one or more characters will be recognized by the word processing application as a revision; and
replace the one or more characters in the blackline markup to the toggling range.

19. The apparatus of claim 13, wherein to convert the blackline markup, the processor is further configured to determine whether the blackline markup is underlined or struckthrough, and in response to a determination that the blackline markup is struckthrough:
format the one or more characters in the blackline markup to remove the strikethrough;
activate tracking of markups such that an insertion or deletion of one or more characters will be recognized by the word processing application as a revision; and
delete the one or more characters in the blackline markup from the toggling range.

20. The apparatus of claim 13, wherein to convert the blackline markup, the processor is further configured to:
determine that the selected one or more characters in the toggling range includes a first pair of consecutive characters consisting of two open brackets;
in response to the determination that the toggling range includes the two open brackets, determine that:
the selected one or more characters in the toggling range includes a second pair of consecutive characters consisting of two closed brackets; and
a number of characters between the two open brackets and the two closed brackets does not exceed a predetermined number of characters;
in response to the determinations that the toggling range includes the two closed brackets and that the predetermined number of characters is not exceeded:
identify the characters between the two open brackets and the two closed brackets as the blackline markup;
delete the two open brackets and the two closed brackets; and
format the blackline markup with strikethrough.
